(19) United States
(12) Patent Application Publication
(10) Pub. No.: US 2025/0047113 A1
(43) Pub. Date: Feb. 6, 2025

(54) POWER MONITORING SYSTEM FOR RACE CAR AUXILIARY BATTERY

(71) Applicant: Black Belt Racing LLC, Seymour, IN (US)

(72) Inventors: Kevin Gene Fleetwood, Seymour, IN (US); Troy B. Davis, Bloomfield, IN (US)

(73) Assignee: Black Belt Racing LLC, Seymour, IN (US)

(21) Appl. No.: 18/792,944

(22) Filed: Aug. 2, 2024

Related U.S. Application Data
(60) Provisional application No. 63/517,201, filed on Aug. 2, 2023.

(51) Int. Cl. H02J 7/00; B60R 16/023; B60R 16/033; B60S 5/06

(52) U.S. Cl. CPC H02J 7/0025; B60R 16/0234; B60R 16/033; B60S 5/06

(57) ABSTRACT

A system configured to monitor a primary battery and a backup battery in a vehicle. The system includes one or more active components, such as a controller, that switch power between the primary battery and the backup battery. The system is configured to switch power from the primary battery to the backup battery when the power level of the primary battery drops below a threshold level. The system is generally implemented on a vehicle having an internal combustion engine. Power from the primary battery is used to start the engine. The backup battery is typically a swappable and interchangeable battery, such as a cordless power tool battery. In one example, the vehicle does not include an alternator.

### CROSS REFERENCE TO RELATED APPLICATIONS

This application claims the benefit of U.S. Patent Application No. 63/517,201, filed Aug. 2, 2023, which is hereby incorporated by reference.

### BACKGROUND

Racing is a very popular sport throughout the world. In any race, the margins between winning and losing can be extremely small. Therefore, racing teams are always looking for an advantage to win the next race.

Thus, there is a need for improvement in this field.

### SUMMARY

With racecars and other types of vehicles, anything that can be done to reduce the overall weight of the vehicle tends to enhance efficiency, thus increasing the range of the vehicle. With racecars powered by internal combustion engines, for example, any increases in the range reduces the number of pit stops which can be the difference between winning and losing a race. For lithium batteries that are typically used in vehicles like race cars, the batteries are charged and performing at the rated voltage or are close to being dead, with a small window between these two states.

A unique power center has been developed to address these as well as other issues. The power center provides a system configured to monitor electrical power levels in a starter battery and an auxiliary or backup electrical power source in a race car. The race car has an internal combustion engine that is configured to be started by power from the starter battery. There is no alternator in the race car in order to reduce weight and parasitic load. The system is configured to switch one or more components powered by the starter battery to the auxiliary power source. The auxiliary electrical power source monitors the primary battery levels and switches power sources to the auxiliary battery to supply electrical power to the ignition box for running the internal combustion engine. Additionally, the system switches the components to the auxiliary power source when the power level of the start battery drops below a threshold. The threshold is a specified voltage level of the starter battery. The configured system includes one or more indicators in a vehicle instrument cluster. The configured system powers the dashboard light gages, helmet blowers for the drivers of the race car and drink systems.

The system is configured to switch one or more components powered by the auxiliary power source to the starter battery in which the auxiliary electric power source includes a cordless power tool battery. The cordless power tool battery is a swappable battery and is configured to be readily removed without tools from the race car to be charged outside the vehicle. The cordless power tool battery utilizes commercially available power tool battery packs from companies like Milwaukee®, DeWalt®, and Snap-On®. The system can be used with cordless power tool batteries starting at 12 volts.

The systems and techniques as described and illustrated herein concern a number of unique and inventive aspects. Some, but by no means all, of these unique aspects are summarized below.

Aspect 1 generally concerns a system.

Aspect 2 generally concerns the system configured to monitor electrical power levels in a starter battery and an auxiliary electrical power source in a vehicle of any previous aspect including a system configured to monitor electrical power levels in a starter battery and an auxiliary electrical power source in a vehicle.

Aspect 3 generally concerns the system configured to monitor electrical power levels in a starter battery and an auxiliary electrical power source in a vehicle of any previous aspect in which the system is configured to switch one or more components powered by the starter battery to the auxiliary power source.

Aspect 4 generally concerns the system configured to monitor electrical power levels in a starter battery and an auxiliary electrical power source in a vehicle of any previous aspect in which the system switches the components to the auxiliary power source when the power level of the starter battery drops below a threshold.

Aspect 5 generally concerns the system configured to monitor electrical power levels in a starter battery and an auxiliary electrical power source in a vehicle of any previous aspect in which the threshold is a specified voltage level of the starter battery.

Aspect 6 generally concerns the system configured to monitor electrical power levels in a starter battery and an auxiliary electrical power source in a vehicle of any previous aspect in which the components include one or more indicators in a vehicle instrument cluster.

Aspect 7 generally concerns the system configured to monitor electrical power levels in a starter battery and an auxiliary electrical power source in a vehicle of any previous aspect in which the components include a helmet blower for a driver of the vehicle.

Aspect 8 generally concerns the system configured to monitor electrical power levels in a starter battery and an auxiliary electrical power source in a vehicle of any previous aspect in which the system is configured to switch one or more components powered by the auxiliary power source to the starter battery.

Aspect 9 generally concerns the system configured to monitor electrical power levels in a starter battery and an auxiliary electrical power source in a vehicle of any previous aspect in which the backup battery includes a cordless power tool battery.

Aspect 10 generally concerns the system configured to monitor electrical power levels in a starter battery and an auxiliary electrical power source in a vehicle of any previous aspect in which the cordless power tool battery is a swappable battery that is configured to be readily removed without tools from the vehicle to facilitate charging outside of the vehicle.

Aspect 11 generally concerns the system configured to monitor electrical power levels in a starter battery and an auxiliary electrical power source in a vehicle of any previous aspect in which the vehicle has an internal combustion engine.

Aspect 12 generally concerns the system configured to monitor electrical power levels in a starter battery and an auxiliary electrical power source in a vehicle of any previous aspect in which the internal combustion engine is configured to be started by power from the starter battery.

Aspect 13 generally concerns the system configured to monitor electrical power levels in a starter battery and an auxiliary electrical power source in a vehicle of any previous aspect in which the system is configured to switch all electrical power functions to the auxiliary power source except for starting the internal combustion engine.

Aspect 14 generally concerns the system configured to monitor electrical power levels in a starter battery and an auxiliary electrical power source in a vehicle of any previous aspect in which the vehicle does not have an alternator.

Aspect 15 generally concerns the system configured to monitor electrical power levels in a starter battery and an auxiliary electrical power source in a vehicle of any previous aspect in which the auxiliary electrical power source substitutes for the starter battery to supply electrical power to an ignition box for running the internal combustion engine.

Aspect 16 generally concerns the system configured to monitor electrical power levels in a starter battery and an auxiliary electrical power source in a vehicle of any previous aspect in which the vehicle is a race car.

Aspect 17 generally concerns the system of any previous aspect including an active component.

Aspect 18 generally concerns the system of any previous aspect in which the active component includes a controller.

Aspect 19 generally concerns the system of any previous aspect in which the controller is configured to connect a backup battery to and disconnect a primary battery from an electrical load.

Aspect 20 generally concerns the system of any previous aspect in which the backup battery is a swappable battery.

Aspect 21 generally concerns the system of any previous aspect in which the backup battery is toollessly attachable and removable from the vehicle.

Aspect 22 generally concerns the system of any previous aspect including a primary battery configured to provide electrical power to one or more components in a vehicle.

Aspect 23 generally concerns the system of any previous aspect including a backup battery configured to provide electrical power to one or more components in the vehicle.

Aspect 24 generally concerns the system of any previous aspect in which the primary battery and the backup battery are configured to provide power to the same components.

Aspect 25 generally concerns the system of any previous aspect in which the controller is constantly connected to and powered by the backup battery.

Aspect 26 generally concerns the system of any previous aspect in which the active component includes a sensor.

Aspect 27 generally concerns the system of any previous aspect in which the sensor is integrated with the controller.

Aspect 28 generally concerns the system of any previous aspect in which the sensor is a voltage sensor.

Aspect 29 generally concerns the system of any previous aspect in which the active component includes a primary battery sensor and a backup battery sensor.

Aspect 30 generally concerns the system of any previous aspect in which the controller is configured to monitor a charge level of the primary battery.

Aspect 31 generally concerns the system of any previous aspect in which the controller is configured to monitor a charge level of the backup battery.

Aspect 32 generally concerns the system of any previous aspect in which the active component includes a switch configured to switch power between the primary battery and the backup battery for the electrical load.

Aspect 33 generally concerns the system of any previous aspect including a primary battery switch configured to connect and disconnect the primary battery from an electrical load of the vehicle.

Aspect 34 generally concerns the system of any previous aspect including a backup battery switch configured to connect and disconnect the backup battery from the electrical load.

Aspect 35 generally concerns the system of any previous aspect in which the primary battery switch is always in an opposite state from a state of the backup battery switch.

Aspect 36 generally concerns the system of any previous aspect including a battery mount system.

Aspect 37 generally concerns the system of any previous aspect in which the battery

mount system includes a battery adapter mount.

Aspect 38 generally concerns the system of any previous aspect including a battery adapter mount configured to receive the backup battery.

Aspect 39 generally concerns the system of any previous aspect in which the backup battery electrically connects to and physically secures to the battery adapter mount in a single motion.

Aspect 40 generally concerns the system of any previous aspect in which the battery mount system includes a clip.

Aspect 41 generally concerns the system of any previous aspect including a clip configured to secure the backup battery in the battery adapter mount.

Aspect 42 generally concerns the system of any previous aspect in which the clip allows a user to manually release the backup battery from the battery adapter mount.

Aspect 43 generally concerns the system of any previous aspect in which the clip is spring biased.

Aspect 44 generally concerns the system of any previous aspect including a battery rack configured to hold multiple backup batteries.

Aspect 45 generally concerns the system of any previous aspect in which the battery adapter mount is located in a passenger cabin of the vehicle.

Aspect 46 generally concerns the system of any previous aspect in which the battery rack is located in the passenger cabin.

Aspect 47 generally concerns the system of any previous aspect including an electrical power system.

Aspect 48 generally concerns the system of any previous aspect in which the electrical power system is configured to control power supply to an electrical load.

Aspect 49 generally concerns the system of any previous aspect in which the electrical load includes ignition and auxiliary systems.

Aspect 50 generally concerns the system of any previous aspect in which the electrical load includes one or more auxiliary components.

Aspect 51 generally concerns the system of any previous aspect in which the auxiliary components include a dashboard indicator.

Aspect 52 generally concerns the system of any previous aspect including a dashboard indicator configured to display information about electrical power supplied to the vehicle.

Aspect 53 generally concerns the system of any previous aspect in which the dashboard indicator includes a battery charge level indicator.

Aspect 54 generally concerns the system of any previous aspect in which the dashboard indicator indicates whether the primary battery or the backup battery is powering the vehicle.

Aspect 55 generally concerns the system of any previous aspect in which the auxiliary components include a helmet blower.

Aspect 56 generally concerns the system of any previous aspect in which the electrical power system provides power to the vehicle through an ignition switch.

Aspect 57 generally concerns a method.

Aspect 58 generally concerns the method of any previous aspect including starting an engine on a vehicle.

Aspect 59 generally concerns the method of any previous aspect including providing electrical power to the vehicle using a primary battery.

Aspect 60 generally concerns the method of any previous aspect including monitoring a status of the primary battery.

Aspect 61 generally concerns the method of any previous aspect in which the status is a voltage of the primary battery.

Aspect 62 generally concerns the method of any previous aspect including comparing the status of the primary battery to a threshold value.

Aspect 63 generally concerns the method of any previous aspect including observing a status level below the threshold value.

Aspect 64 generally concerns the method of any previous aspect including switching electrical power to the vehicle from the primary battery to a backup battery.

Aspect 65 generally concerns the method of any previous aspect in which the threshold value is a voltage corresponding to a minimum desired battery charge.

Aspect 66 generally concerns the method of any previous aspect including monitoring a status of the backup battery.

Aspect 67 generally concerns the method of any previous aspect in which the status is a voltage of the backup battery.

Aspect 68 generally concerns the method of any previous aspect including comparing the status of the backup battery to a threshold value.

Aspect 69 generally concerns the method of any previous aspect in which the different threshold values are used for the primary battery and the backup battery.

Aspect 70 generally concerns the method of any previous aspect including replacing the backup battery.

Aspect 71 generally concerns the method of any previous aspect including prompting a driver to replace the backup battery.

Aspect 72 generally concerns the method of any previous aspect in which the dashboard indicator notifies the driver to replace the battery.

Aspect 73 generally concerns the method of any previous aspect including monitoring a status of a replacement backup battery.

Aspect 74 generally concerns the system of any previous aspect in which the backup battery substitutes for the primary battery to supply electrical power to an ignition box for running the internal combustion engine on the vehicle.

Aspect 75 generally concerns the system of any previous aspect in which the controller is configured to switch power to the vehicle from the primary battery to the backup battery.

Aspect 76 generally concerns the system of any previous aspect in which the controller is configured to switch power to the vehicle when the charge level of the primary battery is below a threshold value.

Aspect 77 generally concerns the method of any previous aspect in which the status is a battery voltage.

Aspect 78 generally concerns the system of any previous aspect in which the controller is configured to switch one or more components powered by the backup battery to the primary battery.

Aspect 79 generally concerns the system of any previous aspect in which the controller is configured to power all electrical components in the vehicle using the backup battery except when starting the internal combustion engine.

Aspect 80 generally concerns the system of any previous aspect in which the controller is configured to control power supply to one or more auxiliary components on the vehicle.

Aspect 81 generally concerns the system of any previous aspect in which all electrical power to components on the vehicle flows through an ignition switch.

Aspect 82 generally concerns the system of any previous aspect in which the backup battery includes multiple batteries arranged as a battery bank.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a system used in a vehicle according to one example.

FIG. 2 is a block diagram of an electric power system used in the FIG. 1 system.

FIG. 3 is an exploded view of a backup battery mount system used in the FIG. 2 electric power system.

FIG. 4 is a perspective view of an example of a passenger cabin where the FIG. 3 backup battery mount system is mounted.

FIG. 5 is a block diagram of the FIG. 2 electric power system according to one example.

FIG. 6 is a flowchart illustrating a technique for operating the electric power system.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

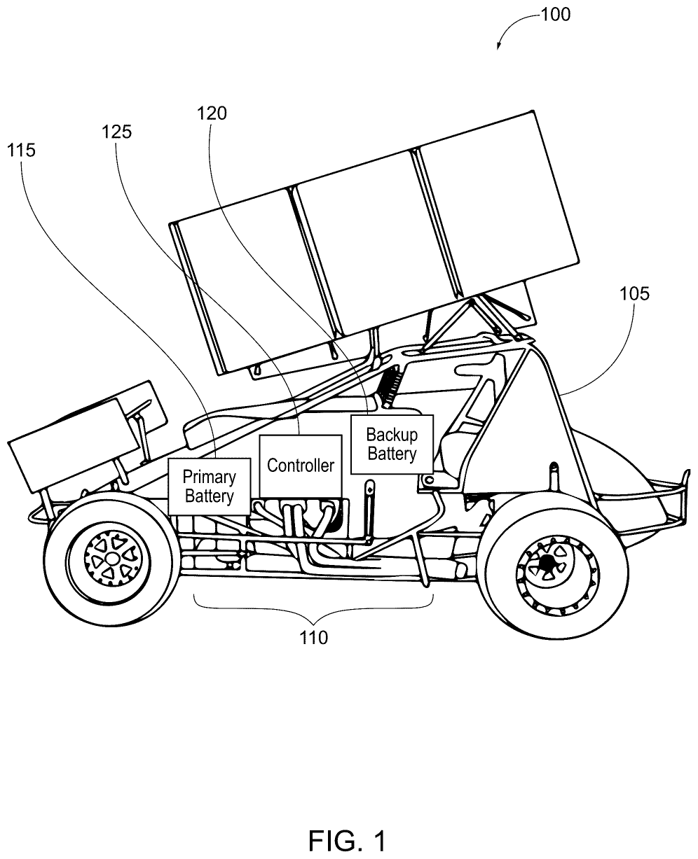

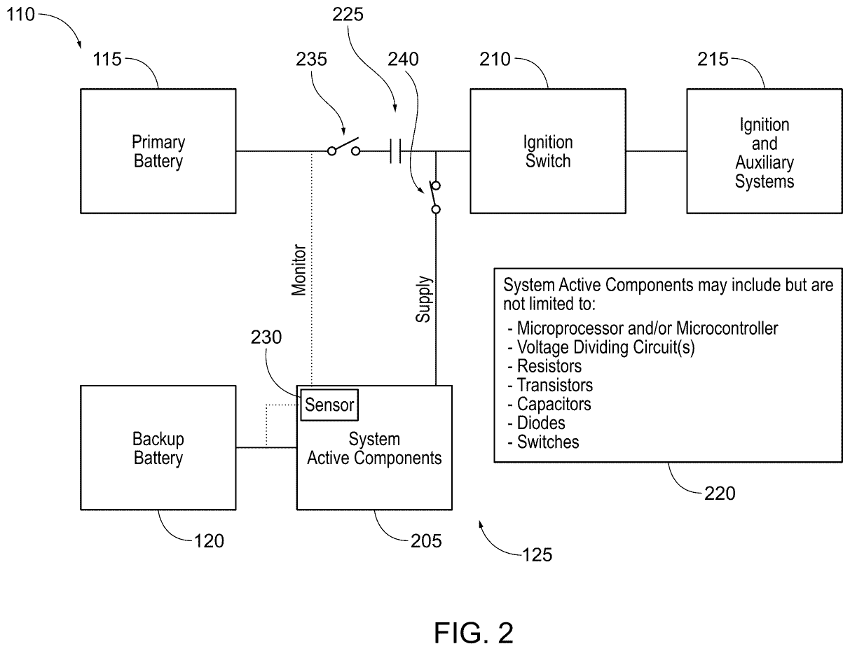

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a block diagram of a system 100 according to one example. The system 100 includes a vehicle 105 and an electric power system 110. The vehicle 105 typically includes an engine, such as an internal combustion engine. The engine provides mechanical power to wheels on the vehicle 105 to propel the vehicle 105. In one form, the vehicle 105 is a dirt track race car. In other forms, the vehicle 105 is another type of race car, such as an asphalt track race car. In some instances, the vehicle 105 is a sprint race car, such as a winged sprint car, midget racecar, mini sprint car, and/or micro sprint car as examples. Such sprint race cars generally have higher power-to-weight ratios and accelerate over shorter distances than most other types of vehicles. As should be appreciated, the system 100 is configured to be used in other types of vehicles.

The electric power system 110 generally supplies electrical power to the vehicle 105. For example, the electric power system 110 supplies power for starting the engine, powering dashboard indicators, and/or powering other components on the vehicle 105. The vehicle 105 generally requires electrical power to start and continue to run the engine. For example, electrical power is needed for a starter motor, an ignition coil, a distributor, and/or other devices to operate an internal combustion engine. The electric power system 110 generally provides electrical power to the engine of the vehicle 105 throughout the duration of a race, such as to ignite fuel in each cylinder of the engine on each engine cycle. The electric power system 110 further provides electrical power to various auxiliary components in the vehicle 105, such as indicators in an instrument cluster, dashboard gauges, helmet blowers for the driver, and/or drink systems as examples.

As illustrated, the electric power system 110 includes a primary battery 115, a backup battery 120, and a controller 125 electrically connected to the primary battery 115 and the backup battery 120. The electric power system 110 is generally configured to switch electrical power for the vehicle 105 between the primary battery 115 and the backup battery 120. Specifically, the electric power system 110 is configured to connect the backup battery 120 to an electrical load of the vehicle while disconnecting the primary battery 115 from the electrical load, and vice versa. In one embodiment, the primary battery 115 is a standard vehicle battery, such as a stock battery on the vehicle 105, and the backup battery 120 is a removable battery.

The primary battery 115 is generally configured to provide electrical power to start the engine, for example by providing voltage to an ignition system and spark plugs in the engine. In one embodiment, the vehicle 105 does not include an alternator or another device to recharge the primary battery 115. By removing the alternator from the vehicle 105, the overall weight of the vehicle 105 is reduced and the load on the engine is reduced. Specifically, removing the alternator eliminates a parasitic load from driving a rotor of the alternator. In racing, reducing weight and engine load is generally desirable to enable the vehicle 105 to accelerate faster and drive at a higher top speed. In particular, sprint racing typically involves faster acceleration than in other types of racing, and small differences in weight or acceleration of the vehicle 105 can affect the outcome of a race. The reduced strain on the engine from removing the alternator can allow the vehicle 105 to run faster and/or accelerate more quickly than other vehicles in a race. In another embodiment, the vehicle 105 includes an alternator and/or another device to recharge the primary battery 115. In one example, the system 100 is configured to be used in asphalt track racing, and the vehicle 105 includes an alternator or similar device. In some instances, the system 100 is configured to recharge the primary battery 115 using the backup battery 120.

The backup battery 120 is similarly configured to provide electrical power to the engine and other components in the vehicle 105. Typically, the backup battery 120 only provides electrical power to the vehicle 105 after a power level of the primary battery 115 drops below a threshold level. Rather than recharging the primary battery 115 using power from the engine, such as via an alternator, the backup battery 120 replaces the primary battery 115 when the power level of the primary battery 115 runs low. Using the backup battery 120 instead of recharging the primary battery 115 allows the vehicle 105 to run with a lower mechanical load on the engine. Again, the lower engine load can allow the vehicle 105 to accelerate and travel at faster speeds than other vehicles having a traditional engine load. In one example, the total weight of the backup battery 120 is less than the weight of an alternator or similar device. Using the backup battery 120 rather than the alternator generally reduces the weight of the vehicle 105, which can further increase acceleration and top speed of the vehicle 105.

The controller 125 is configured to switch electrical connections to one or more components in the system 100 from the primary battery 115 to the backup battery 120. Specifically, the controller 125 is configured to electrically connect one or more components to the backup battery 120 to receive power and electrically disconnect those components from the primary battery 115. As should be appreciated, the controller 125 is configured to connect and/or disconnect such components to the primary battery 115 and/or the backup battery 120. In one embodiment, the controller 125 includes one or more capacitors, diodes, transistors, and/or other electrical components that switch power between the primary battery 115 and the backup battery 120. In some examples, the controller 125 does not include a microprocessor or a computer. Using such circuit components instead of a microprocessor can allow the controller 125 to operate consistently when switching power between the primary battery 115 and the backup battery 120. For instance, such components may operate more reliably than a microprocessor if power to the controller 125 momentarily flickers or turns off during a power source switch. In an alternate embodiment, the controller 125 includes a processor to execute computations and a memory to store information. For example, the controller 125 can include a microprocessor and/or a similar device. As should be appreciated, the system 100 is configured to use a controller 125 in a variety of forms.

The controller 125 further monitors one or more statuses of the primary battery 115, such as a voltage, current output, power output, and/or battery charge as examples. The status of the primary battery 115 can directly or indirectly indicate the remaining charge on the primary battery 115. In one example, the controller 125 is configured to determine the remaining charge of the primary battery 115 based on a voltage measurement, such as using a predetermined voltage-battery charge curve. In another example, the controller 125 determines the remaining charge in another way, such as by measuring and integrating battery current or power output over time. In one version, the primary battery 115 includes multiple batteries arranged as a bank, such as multiple batteries arranged in parallel. In that version, the controller 125 is configured to monitor the bank as a whole to determine the charge level of the primary battery 115.

When the remaining charge of the primary battery 115 drops below a threshold, the controller 125 is configured to switch power to one or more components from the primary battery 115 to the backup battery 120. The controller 125 may switch based on the status of the primary battery 115. For example, the controller 125 switches from the primary battery 115 to the backup battery 120 when a voltage of the primary battery 115 is below a certain level. The threshold voltage can be a voltage level corresponding to 5, 10, 15, or 25 percent of the total charge capacity of the primary battery 115 as examples. In one embodiment, the controller 125 monitors one or more statuses of the backup battery 120 after switching from the primary battery 115 to the backup battery 120. The controller 125 is configured to determine the remaining charge of the backup battery 120 directly or indirectly based on the monitored status of the backup battery 120. In one version, the backup battery 120 includes multiple batteries arranged as a bank, such as multiple batteries arranged in parallel. In that version, the controller 125 is configured to monitor the bank as a whole to determine the charge level of the backup battery 120. Further, the controller 125 is configured to switch power from one backup battery 120 to another backup battery 120 when the remaining charge of that drops below a threshold. In one example, the controller 125 is configured to prompt the driver to replace the used backup battery 120 with a fresh backup battery 120.

The backup battery 120 is typically an interchangeable battery pack. For instance, the backup battery 120 is a swappable battery and is configured to be readily removed from the vehicle 105 without tools. In one embodiment, the backup battery 120 includes a cordless power tool battery. The cordless power tool battery utilizes commercially available power tool battery packs from companies like Milwaukee®, DeWalt®, and Snap-On®. The system 100 can be used with cordless power tool batteries having a variety of characteristics.

The primary battery 115 and the backup battery 120 can have the same or different voltage level, energy storage capacity, maximum current discharge, and/or other specifications. In one embodiment, the primary battery 115 has a full-charge voltage of 12 volts, 16 volts, or 24 volts. In other examples, the system 100 is configured to use a primary battery 115 having a different voltage, such as 18 volts, 20 volts, or another voltage. In one example, the system 100 is configured to use a primary battery 115 having any voltage level. In such an example, the system 100 includes power electronics, such as a buck and/or boost converter, that adjust the voltage level of power received from the primary battery 115. The backup battery 120 can have a different voltage than the primary battery 115. In one example, the backup battery 120 has a full-charge voltage of 16 volts or 20 volts. In other examples, the system 100 is configured to use a backup battery 120 having a full-charge voltage of 12 volts, 18 volts, 40 volts, or another voltage. In one embodiment, the system 100 is configured to use different backup batteries 120 having different voltage levels. For example, the system 100 includes a buck converter and/or other power electronics that step the voltage from the backup battery 120 up or down to meet the requirements of the system 100.

In one example, the storage capacity of the primary battery 115 is greater than the storage capacity of the backup battery 120. The primary battery 115 typically has a storage capacity up to 60 Watt-hours, 120 Watt-hours, 240 Watt-hours, 480 Watt-hours, or another amount. The backup battery 120 generally has a storage capacity up to 40 Watt-hours, up to 60 Watt-hours, up to 120 Watt-hours, or another amount. In one example, the system 100 includes multiple backup batteries 120 that can have different storage capacity levels. The system 100 typically limits the maximum current discharge of the primary battery 115 and backup battery 120 to 20 amps. In one example, the primary battery 115 and/or the backup battery 120 include multiple batteries arranged as a bank. In that example, the maximum current discharge from the primary battery 115 and/or the backup battery 120 is limited based on the number of batteries connected in parallel in the bank.

FIG. 2 shows a schematic for the electric power system 110. As shown, the electric power system 110 includes the primary battery 115, the backup battery 120, and the controller 125. In the illustrated example, the electric power system 110 includes a system active component 205, an ignition switch 210, and one or more ignition and auxiliary systems 215 electrically connected to one another. In the depicted example, the system active components 205 includes system active components examples 220. The system active component 205 for example can include, but is not limited to, one or more microprocessors and/or microcontrollers, voltage dividing circuits, resistors, transistors, capacitors, diodes, and/or switches identified in the box for the system active components examples 220. In the illustrated example, the system active component 205 includes the controller 125. The system active component 205 is generally configured to monitor the primary battery 115 and the backup battery 120 and to control power flow from the primary battery 115 and the backup battery 120 to the components of the vehicle 105. The system active component 205 monitors the primary battery 115 to determine when the charge on the primary battery 115 is depleted to a certain level. The system active component 205 then switches from the primary battery 115 to the backup battery 120 to provide electrical power to the ignition and auxiliary systems 215. In one example, the system active component 205 further regulates power flow from the primary battery 115 and/or the backup battery 120. For instance, the system active component 205 can limit the intensity and direction of current and/or power flow from the primary battery 115 and the backup battery 120 using one or more diodes, transistors, resistors, capacitors, fuses, and/or other components.

The primary battery 115 and the backup battery 120 provide electrical power for the ignition and auxiliary systems 215 through the ignition switch 210. In one example, the ignition switch 210 is a physical switch operated by the driver, such as by inserting and turning a key and/or by pressing a button. The ignition switch 210 is configured to open and close to control electrical power flow to the ignition and auxiliary systems 215 and/or other parts of the vehicle 105. Primarily, the ignition switch 210 provides power to an ignition box and/or other electrical components on the engine. In some embodiments, the ignition switch 210 provides power to all electrical components in the vehicle 105. For example, the ignition switch 210 provides power to the ignition and auxiliary systems 215 and the system active components 205. In another embodiment, the ignition switch 210 provides power to the ignition and auxiliary systems 215 but not the system active components 205. For example, the system active components 205 can be powered by and directly connected to the primary battery 115 and/or the backup battery 120. In the illustrated example, the system active components 205 is connected directly to the backup battery 120 to receive power.

The electric power system 110 generally includes one or more switches 225. In one embodiment, the switches 225 are integrated with the system active components 205. Alternatively, the switches 225 are separate from the system active components 205 but controlled by the system active components 205. The switches 225 typically include one or more transistor switches, relays, and/or other forms of electrical or electromechanical switches. As shown, the switches 225 include a primary battery switch 235 and a backup battery switch 240. The primary battery switch 235 is configured to connect and disconnect the primary battery 115 to the ignition switch 210 and/or other components in the vehicle 105. The backup battery switch 240 is configured to connect and disconnect the backup battery 120 to the ignition switch 210 and/or other components in the vehicle 105. In the FIG. 2 schematic, the primary battery switch 235 is illustrated in an open position and the backup battery switch 240 is illustrated in a closed position. The primary battery switch 235 and the backup battery switch 240 are typically controlled to be in opposite states to each other. In other words, the primary battery switch 235 is always closed when the backup battery switch 240 is open and vice versa. Operating the switches 225 in this way ensures that only one of the primary battery 115 and the backup battery 120 are providing electrical power to the vehicle 105 at a particular instant.

In the illustrated example, the system active components 205 includes one or more sensors 230 that monitor statuses of the primary battery 115 and the backup battery 120. The sensor 230 typically includes one or more voltage probes, voltage comparators, current sensors, coulomb counters, and/or other types of devices. In one embodiment, the sensor 230 is partially or fully integrated into the controller 125 or another device. For example, the controller 125 is configured to determine a voltage difference across terminals on the primary battery 115 and/or the backup battery 120, such as through electrical contacts on voltage probes. In certain embodiments, the sensor 230 is configured to measure other characteristics of the primary battery 115 and/or the backup battery 120, such as battery temperature. In such an example, the sensor 230 includes a thermistor and/or another type of sensor. As should be appreciated, the system active components 205 are configured to process various types of data from the sensor 230 to determine statuses of the primary battery 115 and the backup battery 120.

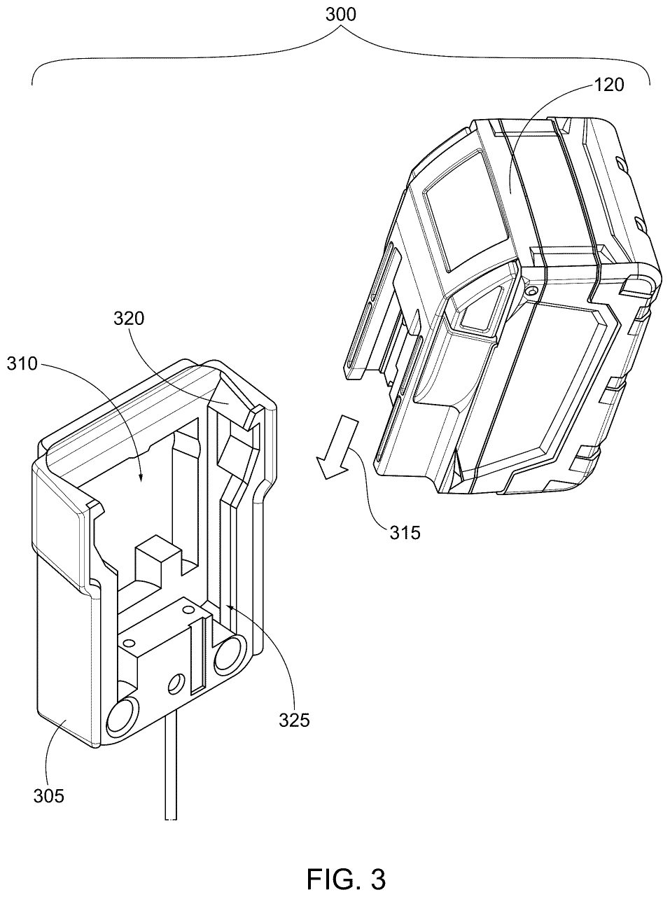

FIG. 3 shows an exploded view of a backup battery mount system 300 that is used to mount and electrically connect the backup battery 120 to the electric power system 110 of the vehicle 105. As shown, the backup battery mount system 300 generally includes the backup battery 120 and a battery adapter mount 305. The battery adapter mount 305 is configured to electrically connect the backup battery 120 to the system active components 205, the backup battery switch 240, and/or another part of the electric power system 110. The battery adapter mount 305 typically includes electrical contacts that electrically connect to terminals on the backup battery 120. For example, the battery adapter mount 305 includes conductive pads, rails, sockets, pins, and/or another type of contact. The battery adapter mount 305 electrically connects to the backup battery 120 when the backup battery 120 attaches to the battery adapter mount 305. The backup battery mount system 300 supports toolless connection of the backup battery 120 and the battery adapter mount 305 in this way. By allowing the backup battery 120 to electrically connect to and physically secure to the battery adapter mount 305 in a single motion, the backup battery mount system 300 supports quick replacement of the backup battery 120. Such quick replacement of the backup battery 120 can save the driver time during, before, or between races.

As shown, the battery adapter mount 305 includes a slot 310. The slot 310 receives the backup battery 120 when the backup battery 120 couples to the battery adapter mount 305. In the illustrated example, the backup battery mount system 300 allows the backup battery 120 to slide into the battery adapter mount 305 in the direction of arrow 315. In alternate examples, the backup battery 120 couples to the battery adapter mount 305 in a direction transverse to the direction of the arrow 315. The backup battery mount system 300 includes one or more tracks 325 that guide the backup battery 120 into the slot 310 in the direction of the arrow 315. In the illustrated example, the battery adapter mount 305 defines the tracks 325 within the slot 310. In another example, the backup battery 120 defines the tracks 325 and/or various portions of the backup battery 120 and the battery adapter mount 305 interlock to function as the track 325. The track 325 generally ensures that electrical contacts on the backup battery 120 and on the battery adapter mount 305 are aligned when coupling the backup battery 120 to the battery adapter mount 305.

The backup battery mount system 300 typically includes a latch, a clasp, and/or another device that detachably secures the backup battery 120 to the battery adapter mount 305. In the illustrated embodiment, the battery adapter mount 305 includes clips 320. The clips 320 are configured to secure the backup battery 120 on the battery adapter mount 305 after sliding into the slot 310. For example, the clips 320 provide little to no resistance when sliding the backup battery 120 into the slot 310 in the direction of the arrow 315, but prevent motion of the backup battery 120 in the opposite direction. In some instances, the clips 320 are spring-loaded and/or biased in another way. In one embodiment, the backup battery mount system 300 includes a button, lever, and/or another control for the driver to disengage the clips 320 from the backup battery 120. The button and/or lever moves the clips 320 or a portion of the backup battery 120 or the battery adapter mount 305 to disengage the clips 320. Either of the backup battery 120 and the battery adapter mount 305 can include the clips 320 and/or the lever. Typically, the button and/or lever is easily handled by the driver to facilitate quick removal of the backup battery 120 when needed. The clips 320 secure the backup battery 120 to the battery adapter mount 305 while allowing the backup battery 120 to be quickly and toollessly removable.

In one embodiment, the backup battery mount system 300 is configured to connect multiple backup batteries 120 to the electric power system 110. For example, multiple batteries can be connected in parallel to form the backup battery 120. In one version, multiple backup batteries 120 are connected in parallel to form a battery bank. In that version, the backup battery mount system 300 includes multiple battery adapter mounts 305 and/or the battery adapter mount 305 includes multiple slots 310 to receive the multiple backup batteries 120. As should be appreciated, the system 100 is configured to utilize a variety of arrangements of the backup battery mount system 300 to support multiple backup batteries 120 connected in various ways.

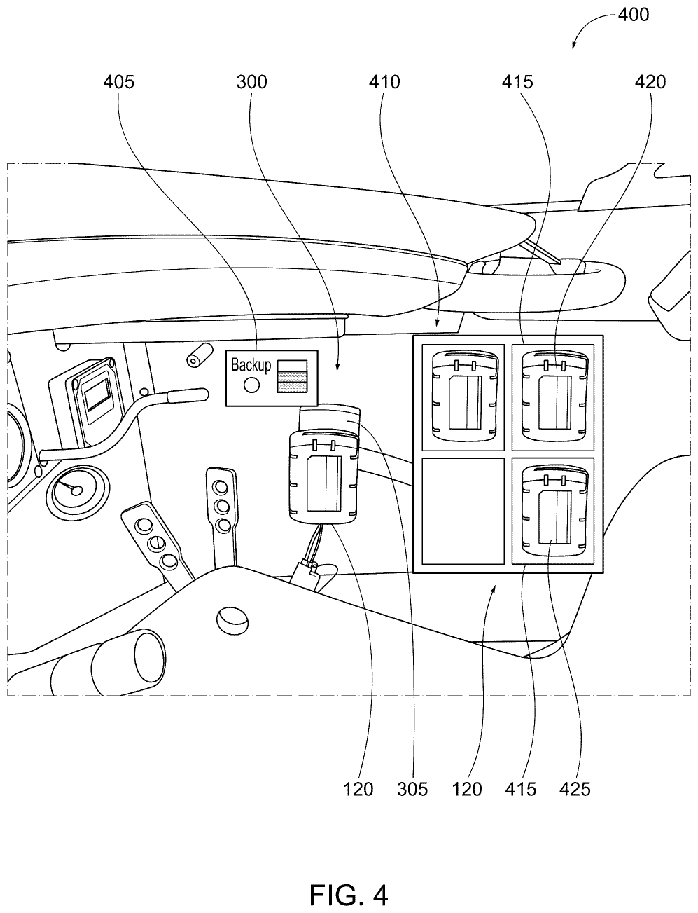

FIG. 4 shows a perspective view of one example of a passenger cabin 400 in the vehicle 105. Typically, the backup battery mount system 300 is mounted in the passenger cabin 400 to be easily accessible to the driver. As shown, the backup battery 120 is attached to the battery adapter mount 305. By positioning the backup battery mount system 300 within the passenger cabin 400, the backup battery 120 can be readily removed from the battery adapter mount 305 and swapped by the driver with a new backup battery 120. This can save precious time before, during, or between races. In one example, the backup battery mount system 300 is positioned on the dominant-hand side of the driver when the driver is seated in the passenger cabin 400. For instance, positioning the backup battery mount system 300 on the right side for a right-handed driver can facilitate fast replacement of the backup battery 120.

The vehicle 105 typically further includes a dashboard indicator 405 in the passenger cabin 400. The dashboard indicator 405 is included with other indicators or gauges in the dashboard of the vehicle 105, or the dashboard indicator 405 is a separate device. The dashboard indicator 405 generally includes one or more lights, LEDs, gauges, display screens, and/or other devices that indicate the status of the electric power system 110. In one example, the dashboard indicator 405 includes a light to indicate when the electric power system 110 switches power from the primary battery 115 to the backup battery 120. The dashboard indicator 405 can indicate such a power source switch using a voltage meter. In one version, the dashboard indicator 405 indicates a power source switch when a reading from a voltage meter drops below a threshold level. In another version, the dashboard indicator 405 displays a voltage level of the primary battery 115 in the form of a voltage meter or gauge. In another example, the dashboard indicator 405 displays the charge level of the primary battery 115 and/or the backup battery 120. In yet another example, the dashboard indicator 405 includes an indicator that notifies the driver when the backup battery 120 needs to be replaced. For instance, the dashboard indicator 405 illuminates when the charge level of the backup battery 120 drops below a certain level.

In one embodiment, the passenger cabin 400 further includes a battery rack 410. The battery rack 410 includes one or more battery holsters 415 to hold the backup batteries 120 when not in use. In one example, the battery holsters 415 are shaped the same as the battery adapter mount 305 and include slots 310 and/or clips 320. The battery rack 410 is configured to hold one or more reserve backup batteries 420 and/or depleted backup batteries 425. The reserve backup batteries 420 are batteries at full charge that the driver may swap for the in-use backup battery 120 when the charge is depleted. The depleted backup batteries 425 are batteries that have been used to power the vehicle 105 and have had the charge depleted below a certain threshold. By providing space for both the reserve backup batteries 420 and depleted backup batteries 425, the passenger cabin 400 allows the driver to easily secure the depleted backup batteries 425 upon removal from the battery adapter mount 305 and to easily locate the reserve backup batteries 420 to refill the battery adapter mount 305. The battery rack 410 helps prevent the backup batteries 120 from coming loose and moving around the passenger cabin 400 during a race. In one version, the battery rack 410 is configured to hold multiple banks formed from multiple backup batteries 120.

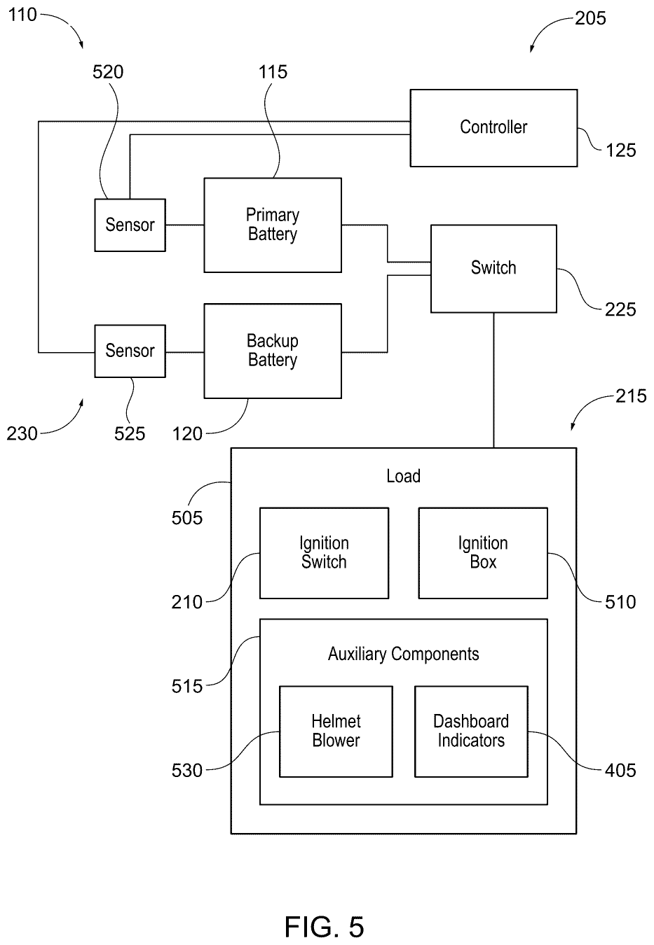

Referring to FIG. 5, the electric power system 110 generally includes an electrical load 505. The electrical load 505 includes components of the vehicle 105 that require electrical power to operate. For instance, the electrical load 505 includes the ignition and auxiliary systems 215. In one example, the electrical load 505 includes all electrical components in the vehicle 105. In another example, one or more components are not included in the electrical load 505, such as the system active components 205 and/or the controller 125. The system active components 205 and/or the controller 125 are optionally constantly connected to the primary battery 115 and/or the backup battery 120 to receive consistent electrical power when the electric power system 110 switches power from the primary battery 115 to the backup battery 120.

The electrical load 505 typically includes the ignition switch 210 and an ignition box 510. The ignition box 510 provides electrical power to the engine throughout the duration of operating the vehicle 105. For instance, the ignition box 510 supplies power to spark plugs in the cylinders of the internal combustion engine. The electrical load 505 further includes one or more auxiliary components 515. The auxiliary components 515 include various devices on the vehicle 105 that do not directly affect operation of the engine. In the FIG. 5 example, the auxiliary components 515 include the dashboard indicator 405 and a helmet blower 530. Again, the dashboard indicator 405 generally includes one or more lights, display screens, and/or gauges that provide information about the electric power system 110 to the driver. The helmet blower 530 generally provides cool air flow to a helmet used by the driver. For instance, the helmet blower 530 can use electrical power to operate a fan and/or cooling system that blow cold air to the helmet. Optionally, the auxiliary components 515 further include a drink system that delivers water and/or other beverages to the driver through the helmet. As should be appreciated, the auxiliary components 515 include various components that aid the driver in a variety of ways during a race. The addition of more auxiliary components 515 can require the driver to stock additional backup batteries 120 on the vehicle 105 to accommodate the increased electrical power draw during a race.

In one embodiment, the total current draw of the electrical load 505 is limited to 20 amps and/or another value. For example, the system active components 205 and/or the controller 125 monitor and limit the current draw of the electrical load 505. In an alternate embodiment, the current and/or voltage across the electrical load 505 is not limited as long as the current and/or voltage output from the primary battery 115 and/or the backup battery 120 is in a normal range.

As illustrated, the system active components 205 generally includes the controller 125, the switches 225, and the sensors 230. In one example, the sensors 230 include a primary battery sensor 520 and a backup battery sensor 525 that monitor voltage, current draw, and/or power draw of the primary battery 115 and backup battery 120 as examples. The primary battery sensor 520 measures one or more statuses of the primary battery 115. The backup battery sensor 525 measures one or more statuses of the backup battery 120. The primary battery sensor 520 and/or the backup battery sensor 525 can be distinct components or integrated with the controller 125. As shown, the primary battery 115 and the backup battery 120 transfer power through the switch 225. In one example, the switch 225 is a single-pole double-throw switch that connects the electrical load 505 to the primary battery 115 in one state and to the backup battery 120 in another state. In another example, switch 225 includes a separate switch for each battery, such as the primary battery switch 235 and the backup battery switch 240 shown in FIG. 2.

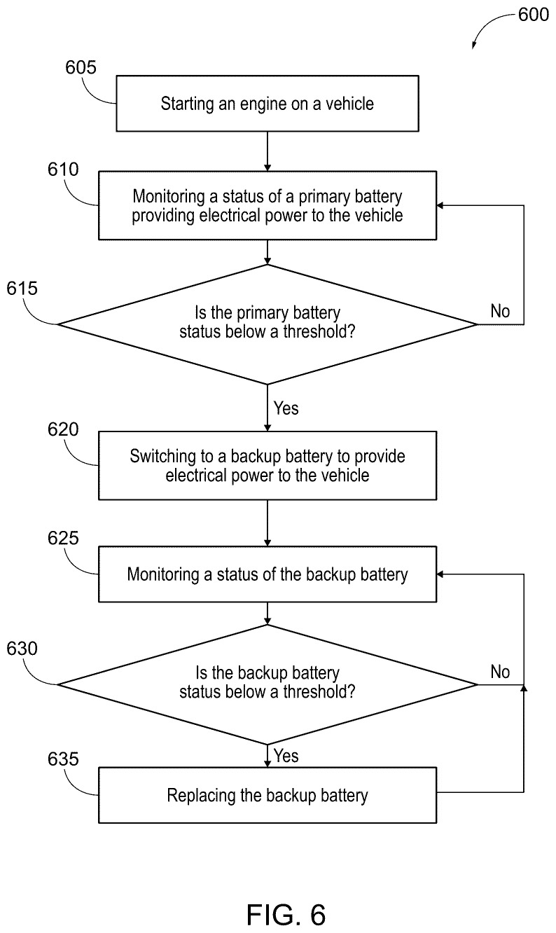

FIG. 6 shows a flowchart 600 illustrating a technique for switching the supply of electricity for the vehicle 105 between the primary battery 115 and the backup battery 120. One or more parts of the technique can be performed by the system 100. Various parts of the system 100 perform different parts of the technique, such as the controller 125, the system active components 205, the sensor 230, and/or other devices. One or more parts of the technique are performed by a human operator, such as a driver of the vehicle 105 and/or a vehicle technician as examples. As should be appreciated, various parts of the technique are performed by the appropriate human operator and/or part of the system 100.

At stage 605, the system 100 starts an engine, such as an internal combustion engine, of the vehicle 105. The system 100 typically starts the engine in response to an input from a driver, such as pressing of a button or turning of a key. The ignition switch 210 generally begins providing electrical power to the engine, such as through the ignition box 510 and/or another part of the ignition and auxiliary systems 215. Typically, the engine receives electrical power from the primary battery 115 at stage 605.

At stage 610, the system active components 205 monitor a status of the primary battery 115 as the primary battery 115 provides electrical power to the electrical load 505. The status includes a voltage, current, and/or another electrical property of the primary battery 115. The system active components 205 monitor the primary battery 115 using the controller 125, the sensor 230, the primary battery sensor 520, and/or another device. Optionally, the system active components 205 monitor a non-electrical property of the primary battery 115, such as a temperature, that can be relevant to battery performance.

As the system active components 205 monitor the primary battery 115, the system active components 205 checks whether the status of the primary battery 115 is below a threshold at stage 615. Specifically, the controller 125 determines whether the status is below the threshold. In one embodiment, the status is the remaining charge on the primary battery 115 and the threshold is a minimum allowed charge level for the primary battery 115. The controller 125 determines the remaining charge on the primary battery 115 directly or indirectly. In one example, the controller 125 determines a remaining charge level of the primary battery 115 based on a voltage measurement on the primary battery 115, such as via a predetermined voltage-charge characteristic curve for the primary battery 115. In another example, the controller 125 tracks current flow from the primary battery 115 and integrates the measurements over time to determine the charge having left the primary battery 115, such as via a coulomb counter or another device. The threshold is typically a minimum charge level or a voltage corresponding to such a minimum charge. In one example, the threshold is 5 percent, 10 percent, 20 percent, and/or 25 percent of total charge remaining on the primary battery 115. In another example, the threshold is a higher remaining charge level, such as 40 percent, 50 percent, and/or 60 percent of total charge remaining on the primary battery 115. If the threshold condition is not met, the system 100 continues to monitor the primary battery 115 at stage 610. If the threshold condition is met, the system 100 continues to stage 620.

At stage 620, the electric power system 110 switches from the primary battery 115 to the backup battery 120 to supply electrical power to the vehicle 105. In one example, the system active components 205 disconnect the primary battery 115 from the electrical load 505 and connect the backup battery 120 to the electrical load 505 using one or more switches 225. In another example, one or more components remain connected to the primary battery 115, such as the controller 125 and/or another device in the system active components 205. Alternatively, such devices are initially electrically connected to the backup battery 120 and remain connected to the backup battery 120 at stage 620. In one embodiment, the system 100 indicates to the driver when power to the vehicle 105 switches from the primary battery 115 to the backup battery 120. For instance, the dashboard indicator 405 changes at stage 620 to show the driver that the backup battery 120 is powering the vehicle 105. As should be appreciated, the electric power system 110 can switch power from the primary battery 115 to the backup battery 120 for the ignition and auxiliary systems 215, the electrical load 505, all devices in the vehicle 105, and/or another subset of devices in the vehicle 105.

The system active components 205 then monitor a status of the backup battery 120 at stage 625. The status includes a voltage, current, and/or another electrical property of the backup battery 120. The system active components 205 monitor the backup battery 120 using the controller 125, the sensor 230, the backup battery sensor 525, and/or another device. Optionally, the system active components 205 monitor a non-electrical property of the backup battery 120, such as a temperature, that can be relevant to battery performance. The system active components 205 can monitor the backup battery 120 in the same way as monitoring the primary battery 115 at stage 610 or in a different way. For example, the system active components 205 optionally operates differently at stage 625 than at stage 610 to account for differences in battery types and/or other characteristics between the primary battery 115 and the backup battery 120.

As the system active components 205 monitor the backup battery 120, the system active components 205 checks whether the status of the backup battery 120 is below a threshold at stage 630. Specifically, the controller 125 determines whether the status is below the threshold. The status for the backup battery 120 is the remaining charge on the backup battery 120 and/or another measurement that corresponds to the remaining charge. The controller 125 determines the remaining charge on the backup battery 120 directly or indirectly, such as by voltage and/or current measurements. In one example, the controller 125 determines the charge level of the backup battery 120 using a different voltage-charge characteristic curve than used for the primary battery 115. As in stage 615, the threshold is typically a minimum charge level or a voltage corresponding to such a minimum charge. In one example, the threshold is 5 percent, 10 percent, 20 percent, and/or 25 percent of total charge remaining on the backup battery 120. In another example, the threshold is lower for the backup battery 120 than for the primary battery 115, such as charge level below 5 percent of the total charge of the backup battery 120. If the threshold condition is not met, the system 100 continues to monitor the backup battery 120 at stage 625. If the threshold condition is met, the system 100 continues to stage 635.

At stage 635, if the backup battery 120 is depleted, then the backup battery 120 is replaced. In one embodiment, the system 100 prompts the driver to replace the backup battery 120. For example, the dashboard indicator 405 notifies the user or driver by turning on a light and/or adjusting a display. The driver then removes the depleted backup battery 425 from the battery adapter mount 305 and attaches the reserve backup battery 420 to the battery adapter mount 305. In another embodiment, the electric power system 110 is wired to multiple backup batteries 120 and automatically switches power from one backup battery 120 to the next backup battery 120 at stage 635. After replacing the backup battery 120 at stage 635, the system 100 continues monitoring the backup battery 120 at stage 625. The technique generally continues until all backup batteries 120 on the vehicle 105 are depleted or until the vehicle 105 is powered down, such as at the end of a race.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Battery” generally refers to a device that converts chemical energy into electrical energy. The battery stores energy in chemical form and then discharges the energy by converting chemical energy into electricity. The battery generally includes one or more electrochemical cells and terminals. The terminals usually include an anode and a cathode.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Controller” generally refers to a device, using mechanical, hydraulic, pneumatic electronic techniques, and/or a microprocessor or computer, which monitors and physically alters the operating conditions of a given dynamical system. In some examples, the controller does not include a microprocessor or a computer. Such controllers typically include electrical components, such as capacitors, diodes, and/or transistors as examples, to alter operating conditions. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Electrical Connection” generally refers to a connection between two objects that allows a flow of electric current and/or electric signals.

“Energy Storage System” (ESS) or “Energy Storage Unit” generally refers to a device that captures energy produced at one time for use at a later time. The energy can be supplied to the ESS in one or more forms, for example including radiation, chemical, gravitational potential, electrical potential, electricity, elevated temperature, latent heat, and kinetic types of energy. The ESS converts the energy from forms that are difficult to store to more conveniently and/or economically storable forms. By way of non-limiting examples, techniques for accumulating the energy in the ESS can include: mechanical capturing techniques, such as compressed air storage, flywheels, gravitational potential energy devices, springs, and hydraulic accumulators; electrical and/or electromagnetic capturing techniques, such as using capacitors, super capacitors, and superconducting magnetic energy storage coils; biological techniques, such as using glycogen, biofuel, and starch storage mediums; electrochemical capturing techniques, such as using flow batteries, rechargeable batteries, and ultra batteries; thermal capture techniques, such as using eutectic systems, molten salt storage, phase-change materials, and steam accumulators; and/or chemical capture techniques, such as using hydrated salts, hydrogen, and hydrogen peroxide. Common ESS examples include lithium-ion batteries and super capacitors.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Interchangeable” generally refers to two or more things that are capable of being put and/or used in place of each other. In other words, one thing is capable of replacing and/or changing places with something else. For example, interchangeable parts typically, but not always, are manufactured to have nearly the same structural size as well as shape within normal manufacturing tolerances and have nearly the same operational characteristics so that one part can be replaced by another interchangeable part. In some cases, the interchangeable parts can be manufactured and/or sold by a specific company under the same part or Stock Keeping Unit (SKU) identifier, and in other cases, different companies can manufacture and/or sell the same interchangeable parts.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

A “Swappable Battery” or “Interchangeable Battery” or “Removable Battery” generally refers to a battery that is toollessly attachable and removable from a mount, holder, rack, and/or receptacle. Some examples of swappable batteries include cordless power tool batteries, game controller battery packs, swappable laptop and/or phone batteries, and others. In many swappable battery systems, the battery electrically connects to and mechanically secures to the mount in one step. For instance, a user can slide or push the swappable battery into the mount to both electrically and mechanically couple the battery to the mount. Swappable batteries generally do not secure to the mount using screws, bolts, or other fasteners that can require a screwdriver, a wrench, or another tool. Typically, swappable battery systems utilize a clip, latch, and/or other biased member to secure the battery after sliding into the mount. The clip or latch can be released with a lever, button, and/or similar mechanism manually actuated by a user. Such a mechanism facilitates attaching and removing the battery to the mount without needing tools. The swappable battery typically has a standardized shape that corresponds to the shape of the receptacle. Some swappable batteries have a standardized shape on a portion that couples to the receptacle, but vary in size on another portion, such as to support connection to batteries with larger or smaller charge capacities. For example, swappable batteries can come in 30 Watt-hour, 40 Watt-hour, 60 Watt-hour, 120 Watt-hour, and/or other energy storage sizes that are all attachable to the same receptacle. The standardized size allows one swappable battery to be removed and replaced in the same mount with another swappable battery. Generally, swappable batteries in a swappable battery system utilize the same voltage. The same voltage on multiple swappable batteries allow the batteries to power the same systems and/or utilize the same battery chargers.

“Switching Device” means a device which is capable of dynamically allowing or interrupting current flow.

“Terminal” generally refers to a plug, socket or other connection (male, female, mixed, hermaphroditic, or otherwise) for mechanically and electrically connecting two or more wires or other conductors.

“Toolless” generally refers to an activity not having and/or requiring tools in order to perform the activity. Typically, the act can be performed manually by an individual.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system

105 vehicle

110 electric power system

115 primary battery

120 backup battery

125 controller

205 system active components

210 ignition switch

215 ignition and auxiliary systems

220 system active components examples

225 switch

230 sensor

235 primary battery switch

240 backup battery switch

300 backup battery mount system

305 battery adapter mount

310 slot

315 arrow

320 clip

325 track

400 passenger cabin

405 dashboard indicator

410 battery rack

415 battery holster

420 reserve backup battery

425 depleted backup battery

505 electrical load

510 ignition box

515 auxiliary components

520 primary battery sensor

525 backup battery sensor

530 helmet blower

600 flowchart

605 stage

610 stage

615 stage

620 stage

625 stage

630 stage

635 stage

What is claimed is:

1. A system, comprising:
a primary battery configured to provide electrical power to one or more components in a vehicle;
a backup battery configured to provide electrical power to one or more components in the vehicle;
a controller configured to switch power to the vehicle from the primary battery to the backup battery;
wherein the backup battery is toollessly attachable and removable from the vehicle; and
wherein the backup battery includes a cordless power tool battery.

2. The system of claim 1, wherein:
the controller is configured to monitor a charge level of the primary battery; and
the controller is configured to switch power to the vehicle when the charge level of the primary battery is below a threshold value.

3. The system of claim 1, wherein:
the vehicle has an internal combustion engine; and
the backup battery substitutes for the primary battery to supply electrical power to an ignition box for running the internal combustion engine on the vehicle.

4. The system of claim 3, wherein the controller is configured to power all electrical components in the vehicle using the backup battery except when starting the internal combustion engine.

5. The system of claim 3, wherein the vehicle does not have an alternator.

6. The system of claim 1, wherein the controller is configured to switch one or more components powered by the backup battery to the primary battery.

7. The system of claim 1, wherein the controller is constantly connected to and powered by the backup battery.

8. The system of claim 1, further comprising:
a dashboard indicator configured to display information about electrical power supplied to the vehicle; and
wherein the dashboard indicator indicates whether the primary battery or the backup battery is powering the vehicle.

9. The system of claim 1, wherein the controller is configured to control power supply to one or more auxiliary components on the vehicle; and the auxiliary components include a helmet blower.

10. The system of claim 1, wherein all electrical power to components on the vehicle flows through an ignition switch.

11. The system of claim 1, further comprising:
a primary battery switch configured to connect and disconnect the primary battery from an electrical load of the vehicle;
a backup battery switch is configured to connect and disconnect the backup battery from the electrical load; and
wherein the primary battery switch is always in an opposite state from a state of the backup battery switch.

12. The system of claim 1, further comprising:
a battery mount system including;
a battery adapter mount configured to receive the backup battery;
wherein the battery adapter mount is located in a passenger cabin of the vehicle; and
wherein the backup battery electrically connects to and physically secures to the battery adapter mount in a single motion.

13. The system of claim 12, wherein the battery mount system includes a clip; wherein the clip is configured to secure the backup battery in the battery adapter mount; and wherein the clip allows a user to manually release the backup battery from the battery adapter mount.

14. The system of claim 12, further comprising:
a battery rack configured to hold multiple backup batteries.

15. A method, comprising:
starting an engine on a vehicle;
providing electrical power to the vehicle using a primary battery;
monitoring a status of the primary battery;
comparing the status of the primary battery to a threshold value;
observing a status level below the threshold value; and
switching electrical power to the vehicle from the primary battery to a backup battery.

16. The method of claim 15, further comprising:
monitoring a status of the backup battery;
comparing the status of the backup battery to a threshold value; and
replacing the backup battery.

17. The method of claim 16, wherein the status is a battery voltage; and wherein the threshold value is a voltage corresponding to a minimum desired battery charge.

18. The method of claim 16, further comprising:
prompting a driver to replace the backup battery; and
wherein a dashboard indicator notifies the driver to replace the battery.

19. The method of claim 17, wherein the vehicle has an internal combustion engine; and the vehicle does not have an alternator.

20. The method of claim 18. further comprising:
monitoring a status of a replacement backup battery.
